(19) United States
(12) Patent Application Publication
(10) Pub. No.: US 2025/0127093 A1
(43) Pub. Date: Apr. 24, 2025

(54) RECEIVER HITCH MOUNTED BALE MOVER

(71) Applicant: Scotty Golden, Crawford, TX (US)

(72) Inventor: Scotty Golden, Crawford, TX (US)

(21) Appl. No.: 18/924,873

(22) Filed: Oct. 23, 2024

Related U.S. Application Data
(60) Provisional application No. 63/592,466, filed on Oct. 23, 2023.

(51) Int. Cl. A01D 87/12; B60D 1/58

(52) U.S. Cl. CPC A01D 87/127; B60D 1/58

(57) ABSTRACT

A receiver hitch mounted bale mover is provided that connects directly to a standard receiver hitch on a vehicle, allowing for quick and easy transport of a bale without removing the tailgate. The bale mover comprises an elongated rigid base member, a rotating spear mount member with multiple spears, and a hydraulic system for rotating the spears between up and down configurations. The hydraulic system may be operated remotely from the vehicle cab. The bale mover is compatible with modern vehicle technologies like backup cameras and can be used with various vehicle types, including flatbed pickups. A stabilizing mechanism provides additional support during transportation over rough terrain. The bale mover allows for trailer connection while mounted and raises the bale sufficiently to maintain tail light visibility during transit.

### CROSS-REFERENCE TO RELATED APPLICATION

This application claims the benefit of U.S. Provisional Patent Application No. 63/592,466, filed Oct. 23, 2023, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. FIELD OF THE INVENTION

The present invention relates generally to agricultural equipment, and more specifically, to a receiver hitch mounted bale mover that mounts directly to a factory pick-up truck tow hitch and allows for quick and easy transport of a bale without having to remove the tailgate.

### 2. DESCRIPTION OF RELATED ART

This background information is intended to further educate the reader as to additional aspects of the prior art and may present examples of specific aspects of the prior art that is not to be construed as limiting the disclosure of the present application.

In the area of agricultural machinery and equipment, various conventional approaches to transporting a round bale hay exist. One such approach includes connecting a bale mover directly to a pick-up truck. Conventional systems have historically required the laborious task of removing the tailgate from the pickup and subsequently connecting it to a gooseneck ball meticulously mounted within the bed of the pick-up truck. Although effective to some extent, this conventional method has been marred by several limitations and complexities that significantly impede its efficiency and practicality.

Firstly, the requirement for the pickup to be equipped with a gooseneck hitch presents a substantial limitation. This prerequisite restricts the versatility of the hay-moving operation, as not all pick-up trucks are fitted with such hitches. Consequently, this limitation places a considerable constraint on the types of pickups capable of effectively utilizing traditional hay-moving systems.

Secondly, the process of removing and reattaching the tailgate of the pick-up truck to accommodate the hay mover is inherently cumbersome and intricate. This results in a time-consuming installation procedure that is neither user-friendly nor conducive to streamlined agricultural operations. The removal of the tailgate, often necessitated by traditional hay movers, disrupts the pick-up truck's standard functionality, making it challenging for operators to seamlessly transition between different tasks.

Moreover, the existing state of hay-moving technology does not capitalize on the technological advancements present in modern pick-up trucks. For instance, the integration of backup cameras in many contemporary pick-up trucks remains an untapped resource in the context of hay-moving equipment. Traditional hay movers fail to leverage this technology effectively, missing an opportunity to enhance the user experience by facilitating easier and more accurate alignment when mounting the hay bale.

Furthermore, while traditional hay movers have their utility, they exhibit limitations in terms of compatibility with various pickup configurations. Specifically, flatbed pickups, which are favored in certain agricultural contexts, often face compatibility issues with conventional hay-moving systems, requiring custom adaptations or specialized equipment.

The existing state of pickup-mounted hay movers has been fraught with limitations and complexities. These limitations include the need for a gooseneck hitch, the laborious removal of the tailgate, underutilization of modern pickup technology, and compatibility issues with flatbed pickups. Thus, in response to these shortcomings, there exists a need for a receiver hitch mounted bale mover that overcomes one or more of the outlined limitations with conventional bale movers.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

The disclosure of the present application described herein represents a significant advancement in the field of hay-moving equipment, addressing the limitations and shortcomings associated with traditional pickup-mounted hay movers. This system enables users to effortlessly and rapidly mount a round bale hay mover to the factory receiver hitch of a pickup truck without the need to remove the tailgate. This not only simplifies the installation process but also preserves the pickup's standard functionality, allowing operators to maintain their workflow without interruption.

One noteworthy advantage of this invention is its compatibility with modern pickups equipped with backup cameras. By capitalizing on the backup camera technology, users can precisely align and mount the hay bale with ease and accuracy. This integration of technology significantly enhances the user experience, making the hay-moving process more efficient and user-friendly.

Moreover, this invention's versatility extends beyond conventional pickups, as it can be seamlessly utilized with flatbed pickups—a substantial improvement over traditional systems that often lack compatibility with such vehicles. This adaptability broadens the range of applications for this invention, catering to a diverse array of agricultural needs.

The core functionality of this invention revolves around a set of spears—a long spear that provides support for the hay bale and two shorter spears that prevent bale rotation during transit. The innovative tilting mechanism of these spears ensures that the bale remains securely in place during transport, eliminating the need for additional strapping to prevent dislodgement of the bale during transit.

Furthermore, the invention incorporates a hydraulic cylinder responsible for elevating the hay bale above the tailgate, facilitating smoother loading and unloading operations. To power this hydraulic system, users have the flexibility to choose between mounting the hydraulic power unit on the hay mover itself or on the pickup, adapting to their specific preferences and requirements. Alternatively, a portable power unit can be easily slid into the bed of the pickup, providing further convenience and versatility.

Additionally, this invention addresses the limitations of the prior art by introducing remote control capabilities for the hydraulic system. Traditional hydraulic jacks required manual cranking and could not be operated from the cab of the pickup. In contrast, this invention offers the convenience of remote control, allowing users to operate the hydraulic system while remaining within the cab.

It is another objective of the present invention to provide an improved receiver hitch mounted bale mover wherein the bale is raised to a sufficient height such that the taillights of the transport vehicle are visible to avoid any hazardous driving conditions or safety concerns during transit.

It is another objective of the present invention to provide an improved receiver hitch mounted bale mover that allows for the connection of a trailer while the bale mover is still mounted to the vehicle, thus eliminating the need for the operator to remove the bale mover prior to connecting a trailer to the tow hitch of the vehicle.

In summary, the invention presents a comprehensive solution to the limitations and shortcomings of conventional pickup-mounted hay movers. It streamlines the installation process, leverages modern pickup technology, offers compatibility with flatbed pickups, enhances safety and stability during transport, and introduces remote control capabilities.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a receiver hitch mounted bale mover in an unloaded and down configuration, in accordance with an embodiment of the present disclosure;

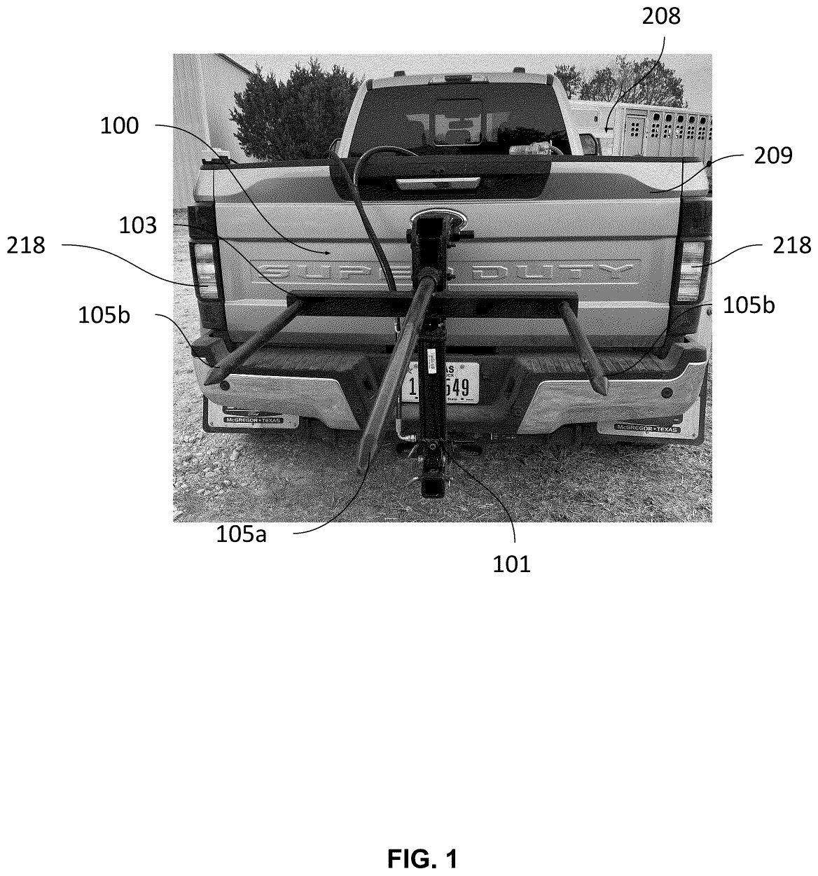

FIG. 2 is a side view of the receiver hitch mounted bale mover in an unloaded and down configuration;

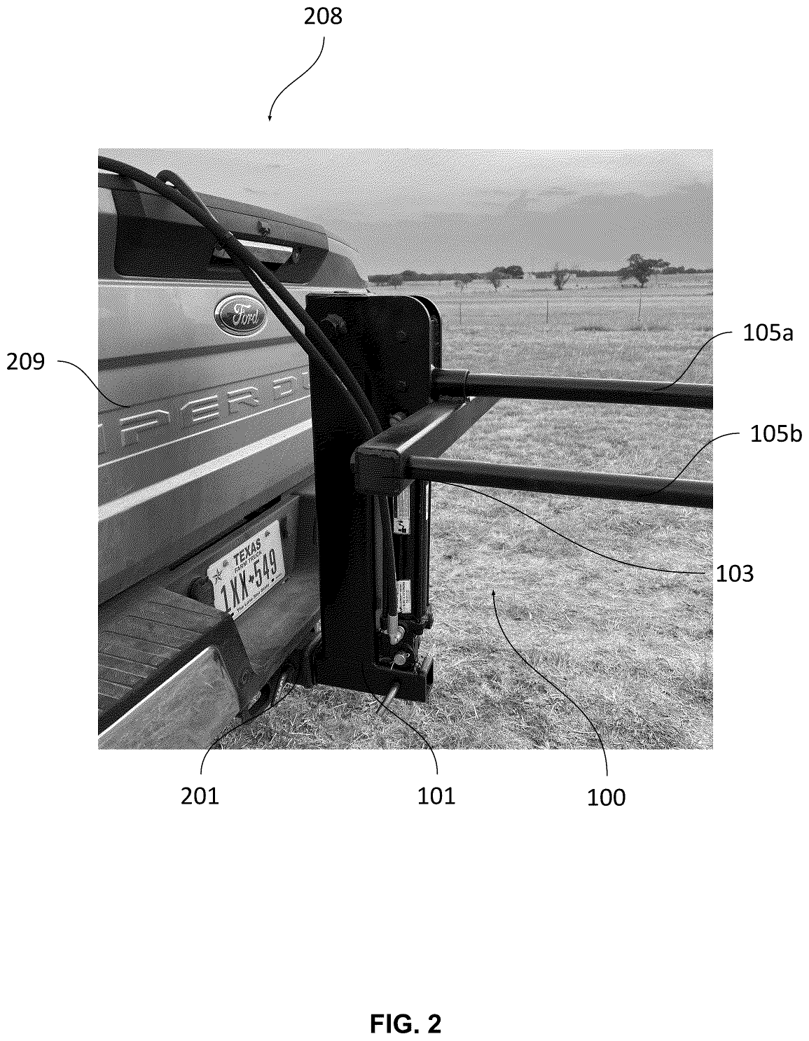

FIG. 3 is a front view of the receiver hitch mounted bale mover in an unloaded and up configuration;

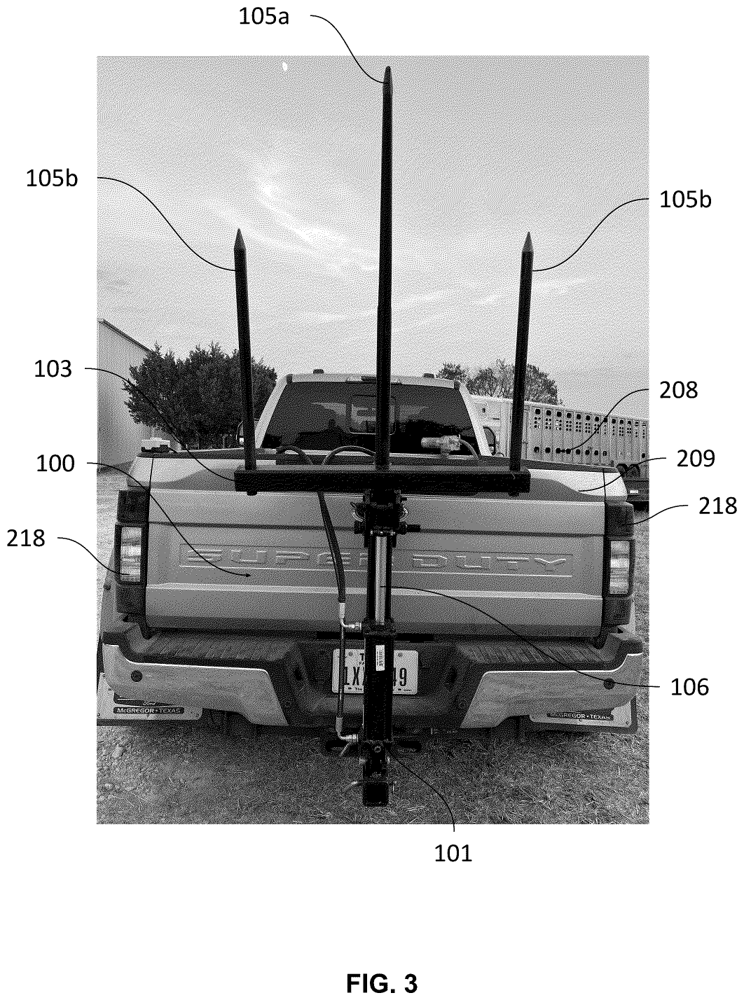

FIG. 4 is a side view of the receiver hitch mounted bale mover in an unloaded and up configuration;

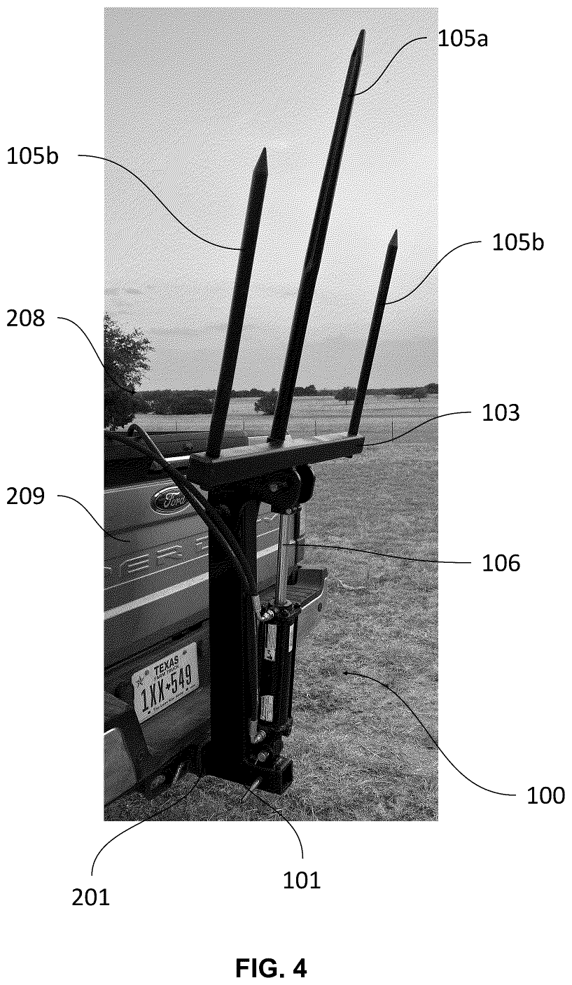

FIG. 5 is a side view of the receiver hitch mounted bale mover in a loaded and down configuration;

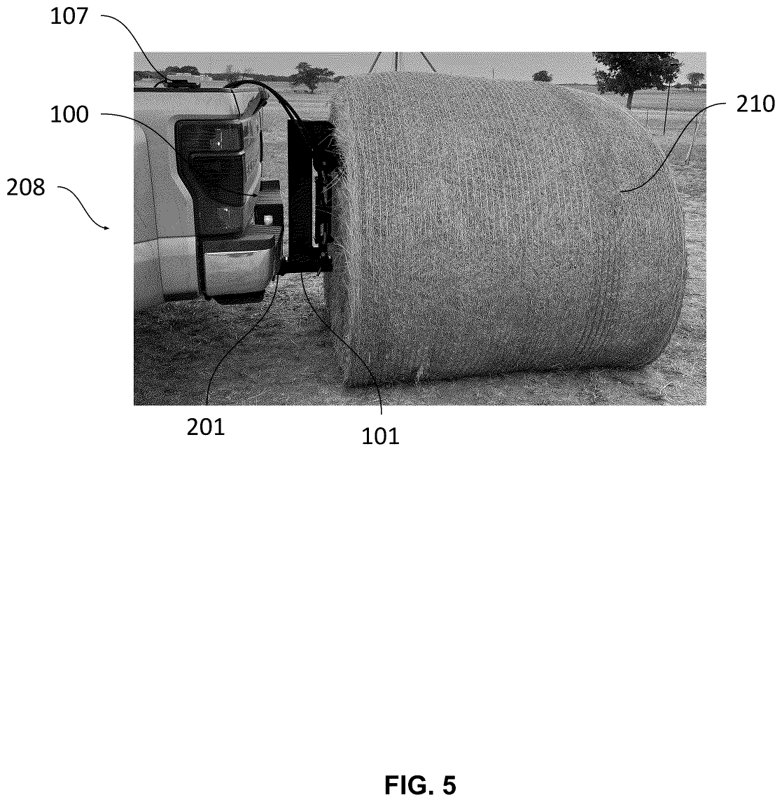

FIG. 6 is a side view of the receiver hitch mounted bale mover in a loaded and up configuration;

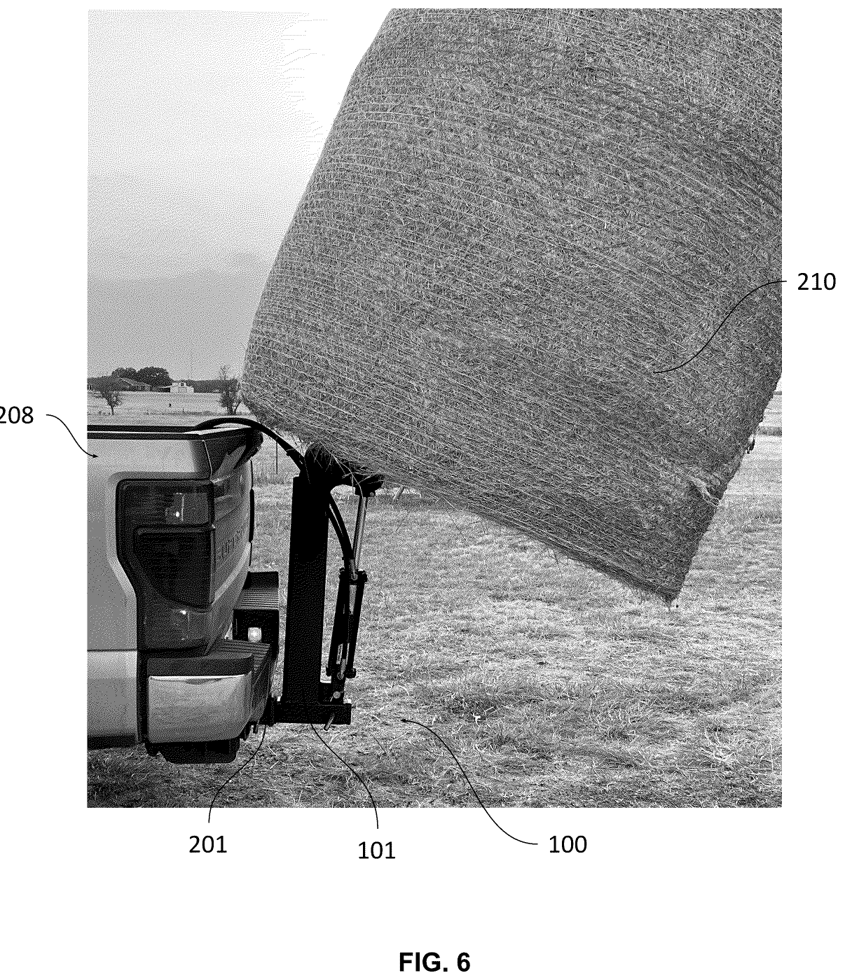

FIG. 7 illustrates an exemplary receiver hitch mounted bale mover configured for use with a truck backup camera; and

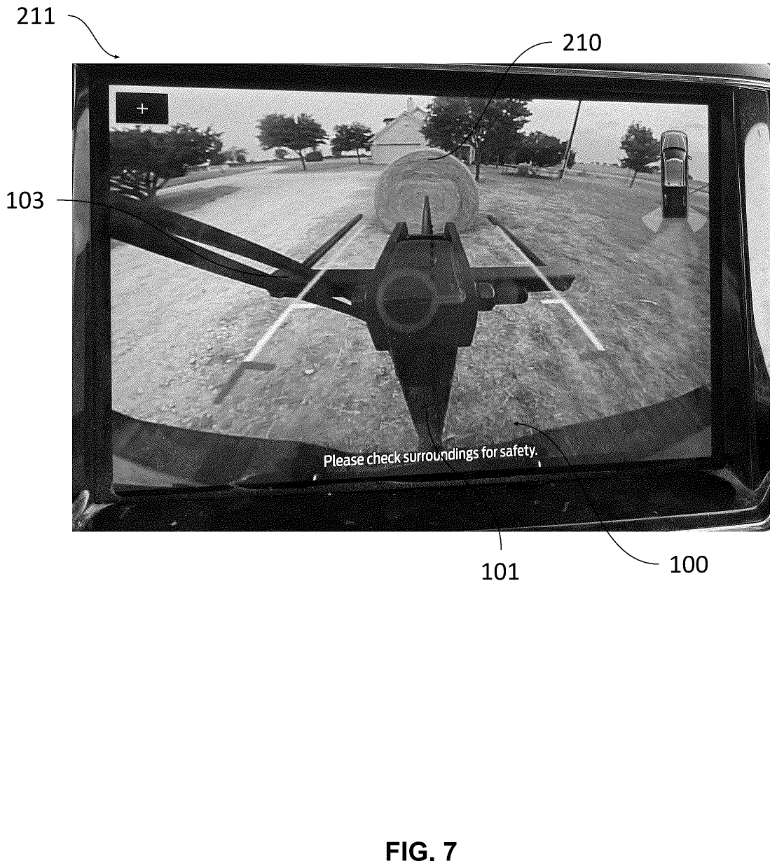

FIG. 8 illustrates an exemplary receiver hitch mounted bale mover configured for use with a stabilizing mechanism.

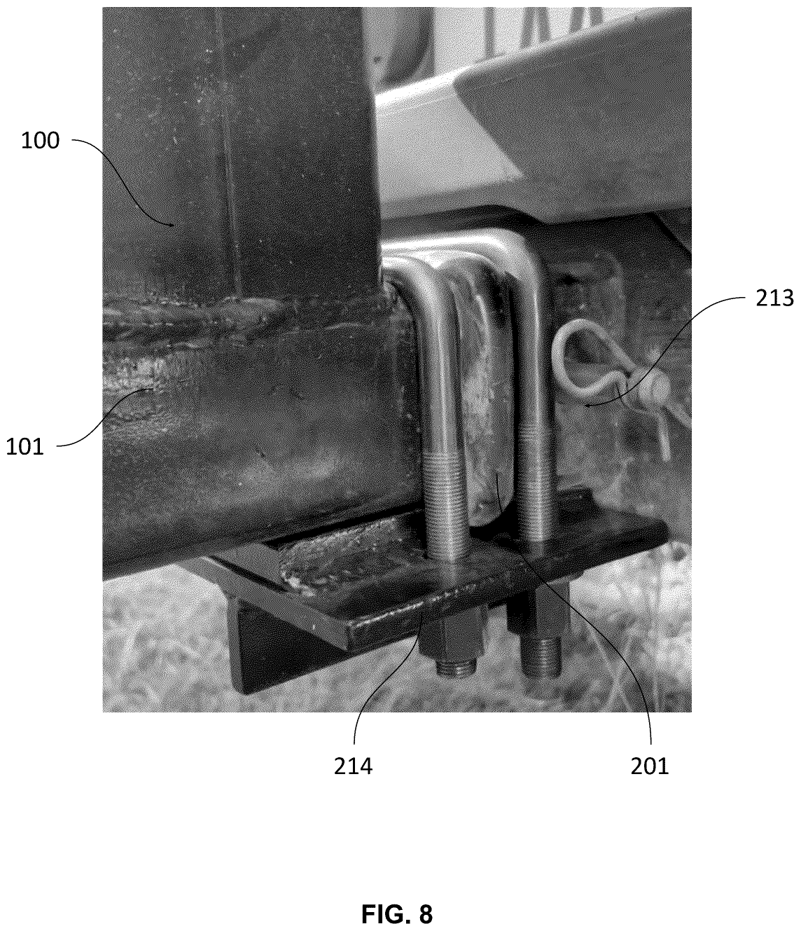

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

While the system and method of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

### DETAILED DESCRIPTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The present application discloses a receiver hitch mounted bale mover 100 that mounts directly to a factory pick-up truck tow hitch 201 and allows for quick and easy transport of a bale 210 without having to remove the tailgate 209. The receiver hitch mounted bale mover 100 includes an elongated rigid base member 101 configured to connect to a standard receiver hitch 201 on a vehicle 208 at one end. At an opposite end, a rotating spear mount member 103 is connected to the base member 101. A plurality of spears 105 are connected to the spear mount member 103. In an exemplary embodiment, there may be one longer support spear 105a and two shorter stabilizing spears 105b on either side of the support spear 105a. A hydraulic cylinder 106 connects the base member 101 and the rotating spear mount member 103 and is configured to allow the spear mount member 103 to rotate between an up configuration and a down configuration. The hydraulic cylinder 106 further includes a hydraulic power unit 107 that can be mounted on the bale mover 100 itself or on the vehicle 208. Alternatively, a portable power unit can be used to allow a user to operate the bale mover 100 remotely such as from within the vehicle cab.

The receiver hitch mounted bale mover 100 may be adaptable to various vehicle 208 models and receiver hitch 201 configurations, making it a versatile solution for a wide range of applications. For example, the spears 105 may be removable and adjustable to various different configurations to accommodate the user's specific needs, such as for a vehicle 208 and/or a bale 210 that is taller or shorter.

It should be appreciated that a unique feature of the present disclosure is its integration with modern vehicle technology, specifically a backup camera 211. In vehicles 208 equipped with a backup camera 211, the hay mover's design is strategically positioned to provide the operator with an unobstructed view of the hay bale 210 during the mounting process improving the overall efficiency.

The integration of the backup camera 211 significantly enhances the ease and accuracy of aligning and mounting the hay bale 210. Operators can monitor the alignment from the cab, eliminating the need for external assistance and minimizing the chances of misalignment or mishaps during the process.

Furthermore, recognizing the prevalence and utility of flatbed pickups in various agricultural contexts, the receiver hitch mounted bale mover 100 design caters to this specific application. The adaptability extends to flatbed pickups, ensuring that operators with these vehicles can also benefit from the convenience and efficiency provided by the receiver hitch mounted bale mover 100.

The hydraulic cylinder 106 is central to the efficient loading and unloading of hay bales 210. The hydraulic cylinder 106 is responsible for elevating the hay bale 210 above the tailgate 209, facilitating smooth loading and unloading. Furthermore, it should be appreciated that the rotation of the spear mount member 103 is a critical feature of the receiver hitch mounted bale mover 100. This tilting mechanism allows the operator to adjust the angle of the spears 105 to secure the hay bale 210 more effectively. By tilting the spears 105, the bale 210 becomes less prone to shifting or dislodging during transit, eliminating the need for additional strapping.

The hydraulic power unit 107, which drives the hydraulic cylinder 106, may include various installation options. For example, the operator may choose to mount the power unit 107 on the hay mover 100 itself for a more compact and integrated setup. Alternatively, the hydraulic power unit 107 may be mounted directly on the vehicle 208, allowing for easy access and maintenance. For added convenience, a portable power unit may also be available, which can be effortlessly slid into the bed of a pickup or mounted in the cab, providing a mobile power source for the hydraulic system.

The receiver hitch mounted bale mover 100 may include additional safety and convenience features to the operator. For example, the receiver hitch mounted bale mover 100 may raise the hay bale 210 to a sufficient height that allows visibility of the vehicle tail lights 218. This provides a safer environment for the transportation of the hay bale 210, particularly if the vehicle 208 is traveling on public roadways where there are other drivers. Furthermore, the receiver hitch mounted bale mover 100 may allow the operator to connect a trailer directly to the receiver hitch mounted bale mover 100, thus eliminating the need for the operator to remove the bale mover 100 before connecting a trailer to the vehicle tow hitch 201. This allows the operator the convenience of having a trailer for other utility such as hauling industrial equipment or the like while maintaining the bale mover 100 in place for ease of use.

In addition to the core components described above, the receiver hitch mounted bale mover 100 may also include a stabilizing mechanism 213 to enhance stability during transportation, particularly over rough terrain. This stabilizing mechanism 213 is designed to attach to the bale mover 100 and provides additional support to minimize unwanted movement or swaying of the bale 210 during transit.

The stabilizing mechanism 213 may consist of a support member 214 that extends from the main body of the bale mover 100 to the vehicle's 208 frame or bed. The support member 214 can be easily deployed when needed and removed when not in use, allowing for versatility in various transportation scenarios. The support member 214 may be constructed from durable materials such as high-strength steel to withstand the stresses of rough road conditions.

Furthermore, the stabilizing mechanism 213 may incorporate shock-absorbing elements, such as heavy-duty springs or hydraulic dampers, to help absorb vibrations and impacts from uneven road surfaces. This feature not only enhances the stability of the bale 210 during transport but also helps protect both the bale 210 and the vehicle 208 from potential damage caused by excessive movement.

The stabilizing mechanism 213 can be designed to be easily adjustable, allowing operators to fine-tune the level of support based on the specific conditions of the road and the size or weight of the bale 210 being transported. This adjustability ensures optimal performance across a wide range of transportation scenarios, from smooth highways to rough farm tracks.

By incorporating this stabilizing mechanism 213, the receiver hitch mounted bale mover 100 further enhances its utility and safety features, addressing the challenges of transporting large bales 210 over varied terrain. This addition aligns with the overall design philosophy of the bale mover 100, which aims to provide efficient, safe, and user-friendly solutions for agricultural transportation needs.

The receiver hitch mounted bale mover 100 may also include a remote control system that allows the operator to control the hydraulic system from within the cab of the vehicle 208. This feature enhances convenience and safety by eliminating the need for the operator to exit the vehicle 208 to operate the bale mover 100.

The description disclosed herein for the receiver hitch mounted bale mover 100 highlights its technical components, functionality, and adaptability to various pickup configurations. The receiver hitch mounted bale mover 100 described herein overcomes one or more of the limitations found in the prior art. These and other features provided herein constitute a significant improvement in the area of tow hitch mounted hay bale movers.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

What is claimed is:

1. A receiver hitch mounted bale mover, comprising:
an elongated rigid base member configured to connect to a standard receiver hitch on a vehicle;
a rotating spear mount member connected to the base member;
a plurality of spears connected to the spear mount member;
a hydraulic cylinder connecting the base member and the rotating spear mount member, configured to allow the spear mount member to rotate between an up configuration and a down configuration; and
a hydraulic power unit operatively connected to the hydraulic cylinder.

2. The receiver hitch mounted bale mover of claim 1, wherein the plurality of spears comprises one longer support spear and two shorter stabilizing spears.

3. The receiver hitch mounted bale mover of claim 1, wherein the hydraulic power unit is mounted on the bale mover.

4. The receiver hitch mounted bale mover of claim 1, wherein the hydraulic power unit is mounted on the vehicle.

5. The receiver hitch mounted bale mover of claim 1, wherein the hydraulic power unit is a portable power unit configured to be placed in a bed of the vehicle.

6. The receiver hitch mounted bale mover of claim 1, further comprising a remote control system configured to operate the hydraulic system from within a cab of the vehicle.

7. The receiver hitch mounted bale mover of claim 1, wherein the rotating spear mount member is configured to tilt the plurality of spears to secure a hay bale during transit.

8. The receiver hitch mounted bale mover of claim 1, wherein the plurality of spears are removable and adjustable to accommodate different vehicle and bale configurations.

9. The receiver hitch mounted bale mover of claim 1, further comprising a stabilizing mechanism attachable to the bale mover to stabilize it during transportation over rough terrain.

10. The receiver hitch mounted bale mover of claim 9, wherein the stabilizing mechanism comprises an adjustable support member that secures the bale mover to the vehicle's receiver hitch.

11. The receiver hitch mounted bale mover of claim 9, wherein the stabilizing mechanism includes shock-absorbing elements to absorb vibrations and impacts from uneven road surfaces.

12. A method of transporting a bale using a receiver hitch mounted bale mover, the method comprising:
connecting an elongated rigid base member to a standard receiver hitch on a vehicle;
rotating a spear mount member connected to the base member using a hydraulic cylinder;
engaging a plurality of spears connected to the spear mount member with a bale;
elevating the bale above a tailgate of the vehicle using the hydraulic cylinder; and
transporting the bale while maintaining visibility of the vehicle's tail lights.

13. The method of claim 12, further comprising using a backup camera of the vehicle to align the plurality of spears with the bale during engagement.

14. The method of claim 12, further comprising connecting a trailer to the receiver hitch mounted bale mover while the bale mover is mounted to the vehicle.

15. The method of claim 12, further comprising deploying a stabilizing mechanism to enhance stability during transportation over rough terrain.

16. A receiver hitch mounted bale mover system, comprising:
a bale mover apparatus configured to connect to a standard receiver hitch on a vehicle;
a plurality of spears mounted on the bale mover apparatus;
a hydraulic system for rotating the plurality of spears between an up configuration and a down configuration; and
a stabilizing mechanism attachable to the bale mover apparatus to provide additional support during transportation over rough terrain.

17. The system of claim 16, wherein the stabilizing mechanism comprises an adjustable support member and shock-absorbing elements.

18. The system of claim 16, further comprising a remote control system for operating the hydraulic system from within a cab of the vehicle.

19. The system of claim 16, wherein the bale mover apparatus is configured to allow connection of a trailer while the bale mover apparatus is mounted to the vehicle.

20. The system of claim 16, wherein the plurality of spears are configured to be removable and adjustable to accommodate different vehicle and bale configurations.
